(19) United States
(12) Patent Application Publication
(10) Pub. No.: US 2013/0039081 A1
(43) Pub. Date: Feb. 14, 2013

(54) RETRACTABLE BOAT LIGHT

(71) Applicants: John Czipri, Boone, NC (US); Bernd Czipri, Palm Harbor, FL (US)

(72) Inventors: John Czipri, Boone, NC (US); Bernd Czipri, Palm Harbor, FL (US)

(73) Assignee: R & D SHED, L.L.C., CLEARWATER, FL (US)

(21) Appl. No.: 13/207,103

(22) Filed: Aug. 10, 2011

(51) Int. Cl. B60Q 1/00

(52) U.S. Cl. 362/477

(57) ABSTRACT

A retractable navigation light mounts through a surface of an aquatic vehicle such as a boat. The navigation light, in the retracted position, is substantially flush with the surface to which it is mounted, thereby reducing clutter and tripping issues. The illuminated portion of the retractable navigation light, in the extended position, is elevated sufficiently as to position the light(s) above any obstruction such as a trolling motor. The illuminated portion locks in the extended position so as to not retract as the boat pounds against waves and unlocks with the push of a button when it is desired to retract the navigation lights. In some embodiments, the extension shaft on which the illuminated portion is mounted is sufficiently sturdy as to provide a safety handle should one slip on the deck of the boat.

### FIELD

This invention relates to navigation lights for boats and more particularly to a retractable navigation light for boats.

### BACKGROUND

Retractable cleats and other similar devices are widely used within boats for securing mooring lines and the like thereto. These retractable cleats typically include a base member, and a retractable cleat member that is telescopingly received within the interior of the base.

Navigation lights are an important safety feature for all boats, especially when the boat is used during the evening hours or in inclement weather, where visibility by other boats is reduced. Navigation lights are required for all recreational boats. Required lights include a red light visible from the port side of the boat, a green light visible the starboard side of the boat and a white light such as a stern light. For safety reasons, the red (port) and green (starboard) must be visible from dead ahead to 112.5 degrees aft on each side and the white all-around light must be visible for a full 360 degrees.

For many boats, such as flats boats, a trolling motor is often mounted on the bow. This trolling motor, as well as other obstructions, often blocks visibility of most gunnel mounted navigation lights. One solution to this problem is to raise the navigation lights to a height greater than the trolling motor. This is often done with a pole or other extension, raising the navigation lights around 12-18 inches above the deck or surface of the boat to clear the obstruction.

A fixed pole can also raise a light above obstructions, but most fishing happens during daylight hours and the fixed pole will get in the way and cause a tripping/safety hazard. A removable pole is one solution to this problem, but this solution has several limitations. First, the removable pole is easy to misplace, lose, or drop overboard. Second, the pole must include electrical contacts to complete a circuit when the pole is installed. The electrical contacts often corrode, causing failure or sporadic operation, especially after exposure to salt-water.

Another solution is a motorized retracting/extending light that uses a motor to extend a telescoping pole with navigation lights at the end. This solution reduces issues related to losing the pole and contacts, but introduces several other problems including reliability of the motor that performs the extending, excess cost, added weight of the extension mechanism, etc. One would not want to be out on a boat at night when the motor failed and the navigation light does not extend.

What is needed is a manually extendable/retractable navigation light that is installed into the deck or gunnels of a boat.

### SUMMARY OF THE INVENTION

A retractable navigation light mounts through a surface of a boat. The retractable navigation light, in the retracted position, is substantially flush with the surface/deck to which it is mounted, thereby reducing clutter and tripping issues. The an illumination section of the retractable navigation light, in the extended position, is elevated sufficiently as to position signal light above any obstruction such as a trolling motor, etc. The illumination section locks in the extended position so as to not retract as the boat pounds against waves and unlocks with the push of a button when it is desired to retract illumination section. In some embodiments, the extension shaft on which the light(s) are mounted is sufficiently sturdy as to provide a safety handle should one slip on the deck of the boat.

In one embodiment, a retractable/extendable boat light is disclosed including a stationary portion and a manually extendable/retractable portion. The stationary portion has at least one screw hole for accepting a fastener to mount the stationary portion in a hole of a surface of an aquatic vehicle. The stationary portion is stationary with respect to the aquatic vehicle (e.g. it moves as the aquatic vehicle/boat moves) and the stationary portion has a holder cavity and a shaft retaining section that are positioned such that, when mounted in the hole, the holder cavity and the shaft retaining section are below the surface of the aquatic vehicle.

The manually extendable/retractable portion includes an extension shaft and an indicator portion. The extension shaft passes through and fits snuggly within the holder cavity of the stationary portion. The indicator portion is fixedly attached to a first end of the extension shaft and includes at least one lamp and at least one lens. The at least one lens allows light from the at least one lamp to exit the indicator portion. The indicator portion sized and shaped to fit within the holder cavity.

The extension shaft includes a stop situated on an outer surface of an end of the extension shaft that is distal from the indicator portion.

The extension shaft also includes a locking device that locks the extension shaft in an extended position wherein the indicator portion is positioned outside of the holder cavity and above the surface of the aquatic vehicle.

In another embodiment, a retractable/extendable boat light for mounting in a hole of a surface of an aquatic vehicle is disclosed. The retractable/extendable boat light includes a stationary portion and an manually extendable/retractable portion. The stationary portion has a fastener surface with at least one screw hole. The stationary portion is mounted to and stationary with respect to the aquatic vehicle. The stationary portion has a holder cavity and a shaft retaining section that are positioned such that, when mounted in the hole, the holder cavity and the shaft retaining section are below the surface of the aquatic vehicle. A bottom surface of the holder cavity includes a ramp.

An extension shaft passes through and fits snuggly within the holder cavity of the stationary portion and an indicator portion is fixedly attached to a first end of the extension shaft. The indicator portion has at least one lamp and at least one lens, the at least one lens allowing light from the at least one lamp to exit the indicator portion. The indicator portion sized and shaped to fit within the holder cavity.

A stop (e.g. a fixed peg) protrudes outwardly from the distal surface of the extension shaft and the stop contacts a lower surface of the shaft retaining section, thereby preventing the extension shaft from exiting the shaft retaining section.

A locking peg and a release button are affixed to a first leg of a u-shaped spring and the u-shaped spring which is situated within the extension shaft such that the locking peg and the release button are urged outwardly through holes in a first side of the extension shaft by a force of the u-shaped spring wherein a second leg of the u-shaped spring pushes against a distal side of the extension shaft. As the indicator portion is pulled towards an extended position, the ramp engages with the release button, thereby deforming the u-shaped spring and moving both the release button and the locking pin inwardly with respect to the extension shaft until the release button and locking pin slide smoothly within the holder cavity. The release button and locking pin restore to their extended position after clearing a top surface of the holder cavity in which position the locking pin abuts the top surface of the holder cavity, thereby locking the extension shaft in the extended position until the release button is manually depressed for moving the extension shaft towards a retracted position.

In another embodiment, a retractable/extendable boat light for mounting in a hole of a surface of an aquatic vehicle is disclosed. The retractable/extendable boat light includes a stationary portion and an manually extendable/retractable portion. The stationary portion has a fastener surface with at least one screw hole and is mounted to and stationary with respect to the aquatic vehicle. The stationary portion has a holder cavity and a shaft retaining section that are positioned such that, when mounted in the hole, the holder cavity and the shaft retaining section are below the surface of the aquatic vehicle. A bottom surface of the holder cavity includes a ramp.

The manually extendable/retractable portion includes an extension shaft and an indicator portion. The extension shaft passes through and fits snuggly within the holder cavity of the stationary portion. The indicator portion is fixedly attached to a first end of the extension shaft and has at least one lamp and at least one lens, the at least one lens allowing light from the at least one lamp to exit the indicator portion. The indicator portion sized and shaped to fit within the holder cavity.

There is a stop which is a fixed peg that protrudes outwardly from the distal surface of the extension shaft. The stop contacts a lower surface of the shaft retaining section, thereby preventing the extension shaft from exiting the shaft retaining section.

A locking peg and a release button are affixed to a first leg of a u-shaped spring and the u-shaped spring is situated within the extension shaft such that the locking peg and the release button are urged outwardly through holes in a first side of the extension shaft by a force of the u-shaped spring. A second leg of the u-shaped spring pushes against a distal side of the extension shaft. The ramp engages with the release button as the indicator portion is pulled towards an extended position, thereby deforming the u-shaped spring and moving both the release button and the locking pin inwardly with respect to the extension shaft until the release button and locking pin slide smoothly within the holder cavity. After clearing a top surface of the holder cavity, the release button and locking pin restore to their extended position the locking pin abuts a top surface of the holder cavity, thereby locking the extension shaft in the extended position until the release button is manually depressed for moving the extension shaft towards a retracted position.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a perspective view of a retractable boat light in an extended and locked mode with the lamp cover removed showing the light source.

FIG. 2 illustrates a perspective view of the retractable boat light in a partially extended mode.

FIG. 3 illustrates a perspective view of the retractable boat light in a fully retracted mode.

FIG. 4 illustrates a cut-away view along line 4-4 of FIG. 3 of the retractable boat light showing an exemplary locking mechanism.

FIG. 5 illustrates a perspective view of the retractable boat light in a partially extended mode and mounted to a boat.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures. Throughout this description, the term “boat” refers to any aquatic vehicle of any size or type including, but not limited to, boats, yachts, jet skis, kayaks, canoes, a dingy, rafts, pontoon boats, etc.

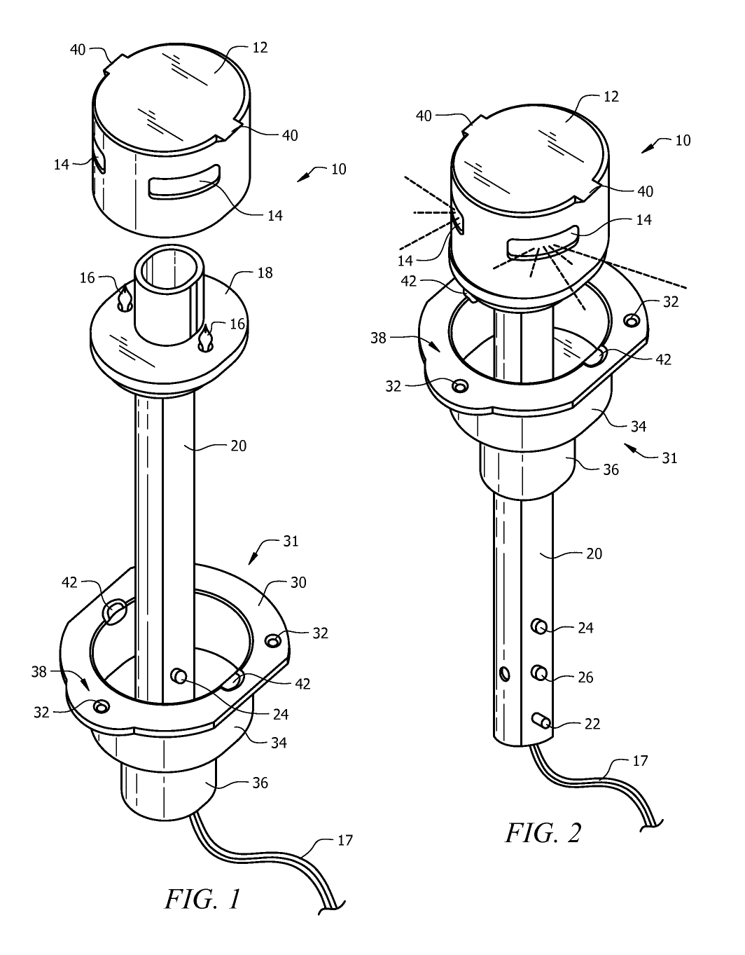

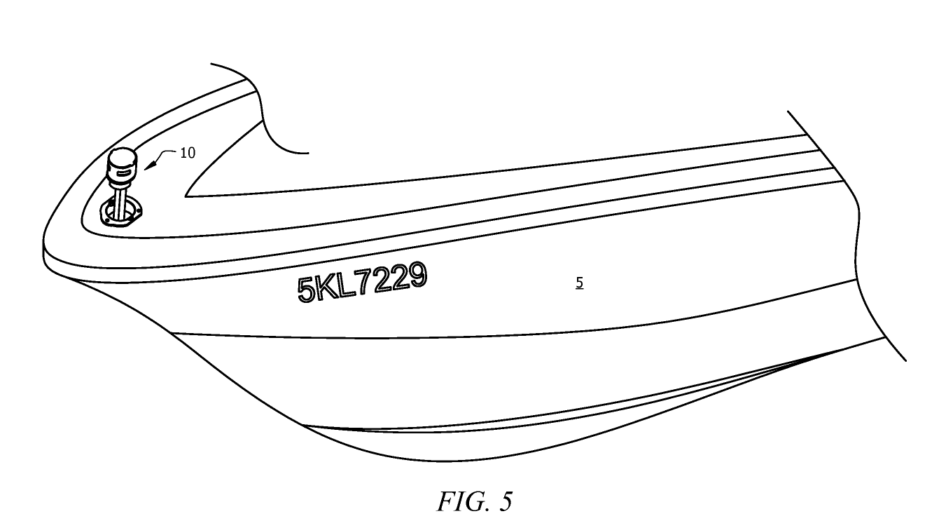

Referring to FIG. 1, a perspective view of a retractable boat light 10 in an extended and locked mode with the lamp covers 12/14 removed showing the light sources 16 will be described. The retractable boat light 10 includes a retractable/extendable portion 12/14/16/18/20/22/24/26/28/40 and a stationary portion 31. The stationary portion 31 is affixed to a deck, gunnel or other surface of an aquatic vehicle such as a boat 5 (see FIG. 5). The indicator portion 12/14/16/18/40 is mounted to an extension shaft 20 and includes a cover 12, a base 18, one or more lenses 14 and one or more lamps 16. Each lamp 16 consists of one or more light emitting elements such as incandescent bulbs, light-emitting diodes (LEDs), florescent bulbs, cold-cathode florescent bulbs (CFLs) or any other light source. In some embodiments, a single lamp 16 provides sufficient light for one or more lenses 14 while in other embodiments, there is number of lamps 16 that corresponds to the number of lenses 14. Any number of lenses 14 and lamps 16 is anticipated. For retractable/extendable navigation lights 10, it is preferred, but not required, to include two lamps 16, each having one or more light emitting elements. In such, there are two lenses 14, both visible from a point directly in front of the boat 5 and the port side lamp 16 being visible from the port side and the starboard side lamp 16 being visible from the starboard side. Either the port side lens 14 and/or the port side lamp 16 is colored red while either the starboard side lens 14 and/or the starboard side lamp 16 is colored green.

As shown in the example of FIG. 1, the base 18 of the indicator portion 12/14/16/18/40 is mounted to an extension shaft 20, although in other embodiments, other portions of the indicator portion 12/14/16/18/40 are mounted to the extension shaft 20, achieving the same purpose, that being holding the indicator portion 12/14/16/18/40 to the extension shaft 20. In some examples, the extension shaft 20 and one or more components of the indicator portion 12/14/18/40 are molded or fabricated as one monolithic part.

The stationary portion 31 is affixed to the boat 5. It is preferred that the stationary portion 31 is fitted within a hole (not shown) made in a surface of the boat 5, the hole preferably being just slightly larger than the outer dimensions of the holder cavity 34 and smaller than the outer perimeter dimensions of the fastener surface 38. After the stationary portion 31 is placed in the hole, one or more fasteners (e.g. screws) are used to hold the stationary portion 31 to the surface of the boat 5. For example, the screws pass through holes 32 in the fastener surface 38 and into/through the surface of the boat 5 as known in the industry.

The stationary portion 31 has a shaft retaining section 36, through which the extension shaft 20 passes. It is preferred that the shape and size of the cross section of the inner surface of the shaft retaining section 36 substantially matches the shape and size of the cross section of the extension shaft 20. In such, the extension shaft 20 fits snuggly within the shaft retaining section 36 and is allowed to move in and out of the shaft retaining section 36 as the indicator portion 12/14/16/18/40 is extended or retracted. In one embodiment, the cross sectional shape of both the extension shaft 20 and the shaft retaining section 36 is oval or oval with flattened sides. This oval cross sectional shape prevents the extension shaft 20 from being rotated within the retaining section 36 and provides a move comfortable hand grip as opposed to a cross-sectional shape that has pointed edges (e.g. rectangular, triangular, etc.). For navigation lights, it is preferred that the extension shaft 20 not be rotatable with respect to the retaining section 36 to maintain the relationship of the red lamp/lens 16 to the port side and the green lamp/lens 16 to the starboard side.

In a preferred embodiment, a flexible wire 17 connects the lamp(s) 16 with a source of power when illumination is desired. In some embodiments, there is no flexible wire 17 and the lamp(s) 16 is/are powered by a power source within the indicator portion 12/14/16/18/40 such as batteries (not shown). In such, it is also anticipated that a solar cell be located on the top surface of the indicator cover 12 for recharging of the power source.

To facilitate lifting the indicator portion 12/14/16/18/40 out of the holder cavity 34, finger grips 40 are provided on an upper surface of the indicator portion 12/14/16/18 while finger spaces 42 are provided on the fastener surface 38, allowing a user to position fingers beneath the finger grips 40 to lift the indicator portion 12/14/16/18/40 out of the holder cavity 34.

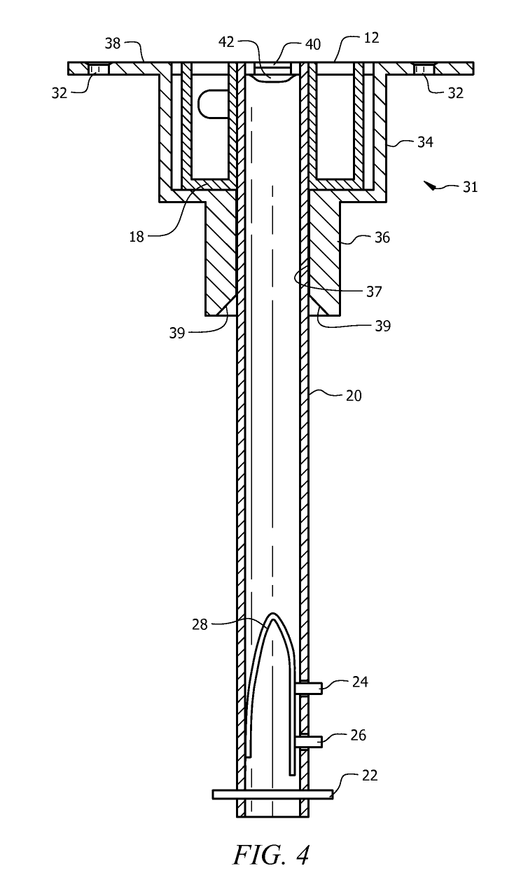

Referring to FIG. 2, a perspective view of the retractable boat light 10 in a partially extended mode is shown. In this view, the indicator portion 12/14/16/18/40 is shown assembled and the lamps 16 (not visible) are illuminated. The exemplary locking peg 26, release button 24 and stop 22 are visible. In operation, pressing the release button 24 causes the locking peg 26 to retract inwardly into the extension shaft 20. As shown in FIG. 4, the indicator portion 12/14/16/18/40 is pulled up, the extension shaft 20 passes through the shaft retaining section 36 until the release button 24 contacts the ramp 39 (see FIG. 4). I some embodiments, the ramp 39 is just wide enough as to contact the release button 24 and/or locking peg 26. In some embodiments, the ramp 39 is wider, for example, covering the entire internal radius of the shaft retaining section 36.

As the extension shaft 20 continues in the upward direction, the release button 24 is wedged inwardly by the ramp 39 and is held in an inward position by the inside surface 37 of the shaft retaining section 36 at least until the locking peg 26 engages with the ramp 39, at which time the ramp 39 wedges the locking peg 26 inwardly into the extension shaft 20 until the extension shaft 20 completes the upward movement, at which both the release button 24 and the locking peg 26 clear the shaft retaining section 36 and both extend outwardly under spring tension of an internal spring 28 (see FIG. 4). At this point, the stop 22 contacts the ramp 39 or bottom surface of the shaft retaining section 36, preventing the extension shaft 20 from being further extended. Likewise, the locking peg 26 extends outward sufficiently from the extension shaft 20 and abuts an upper surface of the retaining section 36, preventing the extension shaft 20 from retracting downward through the stationary portion 31 until the release button 24 is pressed, at which time the locking peg 26 responds by withdrawing inwardly, thereby letting the extension shaft 20 pass downwardly through the shaft retaining section 36. Once the locking peg 26 is within the shaft retaining section 36, the locking peg 26 abuts the inner surface 37 of the shaft retaining section 36, thereby also holding the release button 24 in an inward position so that the release button 24 does not impede further retraction of the extension shaft 20. Once both the locking peg 26 and the release button 24 clear the inner surface 37 of the shaft retaining section 36, both extend outwardly from the extension shaft 20 by force of the spring 28. Other locking/releasing mechanisms are anticipated including, but not limited to, movable flap members, detents, etc.

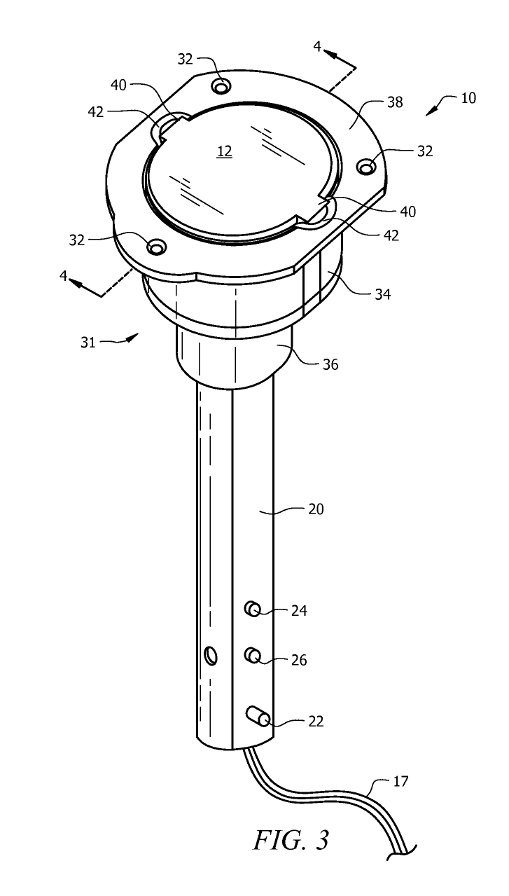

Referring to FIG. 3, a perspective view of the retractable boat light 10 in a fully retracted mode is shown. In this view, the indicator portion 12/14/16/18 is shown fully retracted and located completely within the holder cavity 34. A top surface of the lamp cover 12 is substantially flush with the outer surface of the fastener surface 38, thereby reducing the risk of one tripping over the retractable boat light 10 while in the retracted position. The locking peg 26, release button 24 and stop 22 are shown, but not in use when in the retracted position.

To pull the indicator portion 12/14/16/18/40 upward from the stationary portion 31, one places a finger in one recess 42 and a thumb in the other recess 42, squeezes to hold the indicator portion 12/14/16/18 by the tabs 40, and then pulls the indicator portion 12/14/16/18/40 upwardly out of the holder cavity 34 until the locking peg 26 engages as described above, holding the indicator portion 12/14/16/18/40 in the extended position.

Referring to FIG. 4, a cut-away view of the retractable boat light 10 with an exemplary locking mechanism is shown. Although it is anticipated that in some embodiments the extension shaft 20 is of a solid core, it is preferred that the extension shaft 20 is of a hollow core for passing the power wires 17 and for housing the locking mechanism 24/26/28. The locking mechanism 24/26/28 consists of a u-shaped spring 28 having a release button 24 and a locking pin 26 on one side of the spring such that pressing of the release button 24 deforms the spring 28 and, because the locking pin 26 is on the same leg of the spring 28, the locking pin 26 moves in the same direction, inwardly towards the axis of the extension shaft 20, similar to release buttons on a beach umbrella. As the retractable/extendable portion 12/14/16/18/20/22/24/26/28/40 is extended, the release button 24 slides up against the ramp 39 which forces the release button 24 inwardly towards the axis of the shaft 20, resulting in the spring 28 deforming and the locking pin 26 moving in the same direction, inwardly towards the axis of the extension shaft 20. The inside surface 37 of the shaft retaining section 36 continues to hold the release button 24 in a depressed position until at least the locking pin 26 contacts the ramp 39. At this point, the ramp 39 completely compresses the locking pin 26 and the locking pin 26 remains in the depressed position until it clears the inside surface 37 of the shaft retaining section 36, at which time, both the locking pin 26 and the release button 24 are free and the spring moves the locking pin 26 and the release button 24 outwardly, away from the axis of the extension shaft 20. With the locking pin 26 in a protruding position, the retractable/extendable portion 12/14/16/18/20/22/24/26/28 is now locked in the extended position because the locking pin 26 rests against the top surface of the shaft retaining section 36. To release, the release button 24 is depressed, deforming the spring 28 until the locking pin 26 retracts far enough to clear the top surface of the shaft retaining section 36 and the retractable/extendable portion 12/14/16/18/20/22/24/26/28 is pushed (or falls) downwardly until the indicator portion 12/14/16/18 rests within the holder cavity 34.

Referring to FIG. 5, a perspective view of the retractable boat light 10 in a partially extended mode and mounted on a boat 5 is shown. Although there is no obstruction depicted in this view, it is anticipated that an obstruction such as a trolling motor is mounted on the tip of the bow of the boat 5. In such, a typical flush-mount navigation light would not clear the obstruction and would create a visibility issue during low visibility conditions. The retractable boat light 10 lifts far enough off of the gunnel or other surface of the boat 5 to raise the indicator portion 12/14/16/18 high enough to clear the obstruction. In this, it is anticipated that various models of the retractable boat light 10 will have different length extension shafts 20 to clear different height obstructions and, when retracted, clear internal hull members.

For certain boats 5, especially fishing boats 5 (e.g. flats boats 5), fishermen often walk in all portions of the deck. In such, even if there are no obstructions to visibility of the retractable boat light 10, it is advantageous to retract retractable boat light 10 during daylight hours to reduce the possibility of tripping, etc.

In some embodiments, the retractable boat light 10 is made of a sturdy material such as steel or stainless steel such that, the extension shaft 20 doubles as a handle which is useful in, for example, emergency situations.

Although the retractable boat light 10 has been described with red and green navigation indicator lamps 16, any color lamp is anticipated for any other application, including a white lamp 16 for mounting on the stern of a boat 5.

Equivalent elements can be substituted for the ones set forth above such that they perform in substantially the same manner in substantially the same way for achieving substantially the same result.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A retractable/extendable boat light comprising:
a stationary portion, the stationary portion installed in a hole of a surface of an aquatic vehicle, the stationary portion is stationary with respect to the aquatic vehicle, the stationary portion has a holder cavity and a shaft retaining section that are positioned such that, when mounted in the hole, the holder cavity and the shaft retaining section are below the surface of the aquatic vehicle;
an extension shaft, the extension shaft passing through and fitting snuggly within the holder cavity of the stationary portion; and
an indicator portion, the indicator portion is fixedly attached to a first end of the extension shaft, the indicator portion including at least one lamp and at least one lens, the at least one lens allowing light from the at least one lamp to exit the indicator portion, the indicator portion sized and shaped to fit within the holder cavity;
a stop, the stop situated on an outer surface of a distal end of the extension shaft;
means for releasably locking the extension shaft in an extended position wherein the indicator portion is positioned outside of the holder cavity and above the surface of the aquatic vehicle.

2. The retractable/extendable boat light of claim 1, wherein the means for releasably locking comprises a locking peg and a release button, both the locking peg and the release button are affixed to a first leg of a u-shaped spring and the u-shaped spring is situated within the extension shaft such that the locking peg and the release button are urged outwardly through holes in a first side of the extension shaft by a force of the u-shaped spring wherein a second leg of the u-shaped spring pushes against a distal side of the extension shaft.

3. The retractable/extendable boat light of claim 1, wherein a top surface of the indicator portion includes at least two finger pulls and the stationary portion includes at least two finger spaces, the finger spaces correspondingly located with respect to the finger pulls, the finger pulls assisting in manually lifting the indicator portion out of the holder cavity.

4. The retractable/extendable boat light of claim 1, wherein the at least one lamp comprises at least one light emitting diode.

5. The retractable/extendable boat light of claim 1, wherein the indicator portion includes two lamps and two lenses, the lenses positioned on opposing symmetrical sides of the indicator portion and a first lamp of the two lamps emitting red light and a second lamp of the two lamps emitting green light.

6. The retractable/extendable boat light of claim 1, wherein the indicator portion includes at least one lamp and two lenses, the lenses positioned on opposing symmetrical sides of the indicator portion, the at least one lamp emitting white light, and a first lens of the two lenses being a red filter and second lens of the two lenses being a green filter.

7. The retractable/extendable boat light of claim 1, wherein the indicator portion includes one lamp and one lens, the lens wrapping 360 degrees around the indicator portion and the lamp emitting white light and the lens being uncolored.

8. The retractable/extendable boat light of claim 1, wherein a cross sectional shape of the extension shaft and the shaft retaining section is an oval.

9. The retractable/extendable boat light of claim 1, wherein the stop is a fixed peg that protrudes outwardly from the distal surface of the extension shaft and the stop contacts a lower surface of the shaft retaining section, thereby preventing the extension shaft from exiting the shaft retaining section.

10. The retractable/extendable boat light of claim 1, further comprising a flexible wire having two conductors, a first end of the flexible wire connected to the at least one lamps and a second end of the flexible wire connected to a switchable source of power.

11. A retractable/extendable boat light to mount in a hole of a surface of an aquatic vehicle, the retractable/extendable boat light comprising:
a stationary portion, the stationary portion having a fastener surface with at least one screw hole, the stationary portion is mounted to and stationary with respect to the aquatic vehicle, the stationary portion has a holder cavity and a shaft retaining section that are positioned such that, when mounted in the hole, the holder cavity and the shaft retaining section are below the surface of the aquatic vehicle;
an extension shaft, the extension shaft passing through and fitting snuggly within the holder cavity of the stationary portion; and
an indicator portion, the indicator portion fixedly attached to a first end of the extension shaft, the indicator portion including at least one lamp and at least one lens, the at least one lens allowing light from the at least one lamp to exit the indicator portion, the indicator portion sized and shaped to fit within the holder cavity;
a stop, the stop is a fixed peg that protrudes outwardly from a surface of the extension shaft that is distal from the indicator portion, as the indicator portion is pulled into the extended position, the stop contacts a lower surface of the shaft retaining section, thereby preventing the extension shaft from exiting the shaft retaining section;
a locking peg and a release button, both the locking peg and the release button are affixed to a first leg of a u-shaped spring and the u-shaped spring is situated within the extension shaft such that the locking peg and the release button are urged outwardly through holes in a first side of the extension shaft by a force of the u-shaped spring wherein a second leg of the u-shaped spring pushes against a distal side of the extension shaft.

12. The retractable/extendable boat light of claim 11, wherein a bottom surface of the holder cavity includes a ramp, the ramp engages with the release button as the indicator portion is pulled towards an extended position, thereby deforming the u-shaped spring and moving both the release button and the locking pin inwardly with respect to the extension shaft until the release button and locking pin slide smoothly within the holder cavity, the release button and locking pin restore to their extended position after clearing a top surface of the holder cavity and the locking pin abuts the top surface of the holder cavity, thereby locking the extension shaft in the extended position until the release button is manually depressed for moving the extension shaft towards a retracted position.

13. The retractable/extendable boat light of claim 11, wherein a top surface of the indicator portion includes at least two finger pulls and the stationary portion includes at least two finger spaces, the finger spaces correspondingly located with respect to the finger pulls, the finger pulls assisting in manually lifting the indicator portion out of the holder cavity.

14. The retractable/extendable boat light of claim 11, wherein the at least one lamp comprises at least one light emitting diode.

15. The retractable/extendable boat light of claim 11, wherein the indicator portion includes two lamps and two lenses, the lenses positioned on opposing symmetrical sides of the indicator portion and a first lamp and lens of the two lamps and two lenses emits red light and a second lamp and lens of the two lamps and two lenses emits green light.

16. The retractable/extendable boat light of claim 11, wherein a cross sectional shape of the extension shaft and the shaft retaining section is an oval.

17. A retractable/extendable boat light to mount in a hole of a surface of an aquatic vehicle, the retractable/extendable boat light comprising:
a stationary portion, the stationary portion having a fastener surface with at least one screw hole, the stationary portion is mounted to and stationary with respect to the aquatic vehicle, the stationary portion has a holder cavity and a shaft retaining section that are positioned such that, when mounted in the hole, the holder cavity and the shaft retaining section are below the surface of the aquatic vehicle, a bottom surface of the holder cavity includes a ramp;
an extension shaft, the extension shaft passing through and fitting snuggly within the holder cavity of the stationary portion; and
an indicator portion, the indicator portion is fixedly attached to a first end of the extension shaft, the indicator portion including at least one lamp and at least one lens, the at least one lens allowing light from the at least one lamp to exit the indicator portion, the indicator portion sized and shaped to fit within the holder cavity;
a stop, the stop is a fixed peg that protrudes outwardly from the distal surface of the extension shaft and the stop contacts a lower surface of the shaft retaining section, thereby preventing the extension shaft from exiting the shaft retaining section;
a locking peg and a release button, both the locking peg and the release button are affixed to a first leg of a u-shaped spring and the u-shaped spring is situated within the extension shaft such that the locking peg and the release button are urged outwardly through holes in a first side of the extension shaft by a force of the u-shaped spring wherein a second leg of the u-shaped spring pushes against a distal side of the extension shaft, the ramp engages with the release button as the indicator portion is pulled towards an extended position, thereby deforming the u-shaped spring and moving both the release button and the locking pin inwardly with respect to the extension shaft until the release button and locking pin slide smoothly within the holder cavity, the release button and locking pin restore to their extended position after clearing a top surface of the holder cavity and the locking pin abuts the top surface of the holder cavity, thereby locking the extension shaft in the extended position until the release button is manually depressed for moving the extension shaft towards a retracted position.

18. The retractable/extendable boat light of claim 17, wherein a top surface of the indicator portion includes at least two finger pulls and the stationary portion includes at least two finger spaces, the finger spaces correspondingly located with respect to the finger pulls, the finger pulls assisting in manually lifting the indicator portion out of the holder cavity.

19. The retractable/extendable boat light of claim 17, wherein the at least one lamp comprises at least one light emitting diode.

20. The retractable/extendable boat light of claim 17, wherein a cross sectional shape of the extension shaft and the shaft retaining section is an oval.
